(19) United States
(12) Patent Application Publication
(10) Pub. No.: US 2026/0044169 A1
(43) Pub. Date: Feb. 12, 2026

(54) START-UP CIRCUIT OF A VOLTAGE REFERENCE BANDGAP CIRCUIT

(71) Applicant: STMicroelectronics International N.V., Geneva (CH)

(72) Inventors: Marc SABUT, Eybens (FR); Philippe PIGNOLO, Crolles (FR)

(73) Assignee: STMicroelectronics International N.V., Geneva (CH)

(21) Appl. No.: 19/292,230

(22) Filed: Aug. 6, 2025

(30) Foreign Application Priority Data
Aug. 9, 2024 (FR) FR2408815

(51) Int. Cl. G05F 3/26

(52) U.S. Cl. CPC G05F 3/267

(57) ABSTRACT

This disclosure relates to a start-up circuit for a bandgap circuit for generating a reference voltage, a current mirror of the bandgap circuit including a first MOS transistor. The start-up circuit includes a second transistor and a third transistor in a current mirror configuration, the control terminals of which are coupled through a first resistor, and a fourth MOS transistor between a terminal for applying a supply voltage and a control terminal of the second transistor, the fourth MOS transistor being in a current-mirror configuration with respect to the first MOS transistor.

### PRIORITY CLAIM

This application claims the priority benefit of French Application for Patent No. FR2408815, filed on Aug. 9, 2024, the content of which is hereby incorporated by reference in its entirety to the maximum extent allowable by law.

### TECHNICAL FIELD

This disclosure generally relates to start-up circuits of bandgap reference voltage circuits and their associated operating methods.

### BACKGROUND

Many known electronic devices include a bandgap circuit for generating reference voltage configured to generate a reference voltage that does not vary overall with temperature.

These devices require a start-up circuit to enable them to operate at a preferred operating point.

Current start-up circuits have a number of drawbacks.

There is a need for improving start-up circuits of bandgap circuits that generate reference voltages.

### SUMMARY

One embodiment overcomes some or all drawbacks of known start-up circuits.

One embodiment provides a start-up circuit of a bandgap circuit for generating a reference voltage, the bandgap circuit having a current mirror that includes a first MOS transistor, comprising: a second transistor and a third transistor in a current mirror relationship, the control terminals of which are coupled through a first resistor; and a fourth MOS transistor, between a terminal for applying a supply voltage and a control terminal of the second transistor, the fourth MOS transistor being current-mirrored with respect to the first MOS transistor.

The fourth transistor may be connected directly to the control terminal of the second transistor.

One embodiment provides a method for starting a bandgap circuit for generating a reference voltage, the bandgap circuit having a current mirror that includes a first MOS transistor, the method including disconnecting a start-up circuit from the generation circuit, having: a second transistor and a third transistor in a current mirror relationship, the control terminals of which are coupled through a first resistor, and a fourth MOS transistor between a terminal for applying a supply voltage and a control terminal of the second transistor, the fourth MOS transistor being current-mirrored with respect to the first MOS transistor; by switching ON the fourth transistor.

In one embodiment, a current source couples: the terminal for applying a supply voltage to the control terminal of the third transistor, and the terminal for applying a supply voltage to a conduction node of the second transistor.

In one embodiment, the second transistor couples the control terminal of the third transistor to ground via a second resistor.

In one embodiment, the size of the third transistor is at least N times greater than that of the second transistor, N ranging from 2 inclusive to 10 inclusive.

In one embodiment, the second and third transistors are of the NMOS-type, and the fourth transistor is of the PMOS-type.

In one embodiment, the second and third transistors are of the bipolar-type, and the fourth transistor is of the PMOS-type.

One embodiment provides a bandgap device for generating a reference voltage, comprising the start-up circuit described above, and a bandgap circuit for generating a reference voltage, comprising: a first branch having the first transistor in series with a fifth bipolar transistor; and a third resistor, coupled to ground, in series with a fourth resistor coupled to the emitter of the fifth transistor; the second resistor being configured to receive a voltage proportional to the absolute temperature across its terminals, and the third resistor configured to receive a voltage complementary to the absolute temperature across its terminals.

In one embodiment: the fourth MOS transistor has a control terminal coupled to a control terminal of the first transistor; and the third transistor couples a mid-point of the first and fifth transistors to a mid-point of the third and fourth resistors of the generation circuit.

In one embodiment, the generation circuit comprises a second branch having a sixth transistor in series with a seventh bipolar transistor, control terminals of the fifth and seventh transistors being both coupled to a first node, and the control terminals of the first, fourth, and sixth transistors being coupled to each other.

In one embodiment, the mid-point of the sixth and seventh transistors is coupled to the control terminals of the first, fourth, and sixth transistors.

In one embodiment, the generation circuit comprises a third branch having: an eighth transistor coupling the terminal for applying a supply voltage to an output node of the generation circuit, the control terminal of the eighth transistor being coupled to the mid-point of the first and fifth transistors; a fifth resistor coupling the first node to ground; and a sixth transistor coupling the output node to the first node.

In one embodiment, a capacitor couples the mid-point of the first and fifth transistors to the output node.

In one embodiment, the first, sixth, and eighth transistors are of the PMOS-type.

In one embodiment, the second resistor has a value equal to the value of the third resistor multiplied by N.

In one embodiment, the size of the fifth transistor is at least M times greater than that of the seventh transistor, M ranging from 2 inclusive to 10 inclusive.

One embodiment provides a method for using the device described above, comprising starting the generation circuit by using the start-up circuit, and then switching the start-up circuit off.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates a bandgap device for generating a reference voltage;

FIG. 2 illustrates a block from the device shown in FIG. 1;

FIG. 3 illustrates a block from the device shown in FIG. 1; and

FIG. 4 illustrates a block from the device shown in FIG. 1.

### DETAILED DESCRIPTION

Like features have been designated by like references in the various figures. In particular, the structural and/or functional features that are common among the various embodiments may have the same references and may have identical structural, dimensional and material properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10% or 10°, and preferably within 5% or 5°.

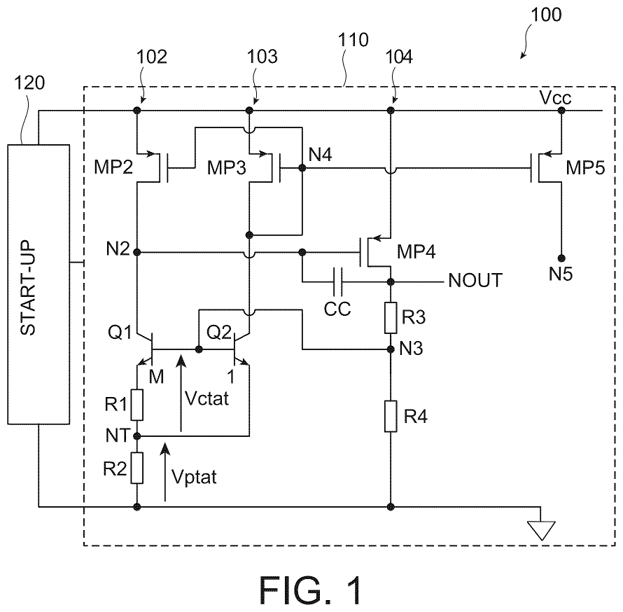

FIG. 1 illustrates a bandgap device 100 for generating a reference voltage.

The device 100 includes a start-up circuit 120 connected to a bandgap circuit 110 for generating a reference voltage.

In the example illustrated, start-up circuit 120 is coupled, preferably connected, to a terminal for applying a voltage Vcc and to ground.

In the example illustrated, the bandgap circuit 110 comprises a first branch 102 having a transistor MP2 in series with a transistor Q1 being bipolar, for example of the NPN-type. Transistor MP2 couples the terminal for applying the supply voltage Vcc to the collector of transistor Q1. The first branch 102 also comprises a resistor R2 coupling ground to a node NT. Resistor R2 is in series with a resistor R1 coupling node NT to the emitter of transistor Q1. In one example, resistor R1 is between 1 kOhms and 10 kOhms (e.g., 3 kOhms), and resistor R2 is between 1 kOhms and 20 kOhms.

In the example illustrated, the bandgap circuit 110 comprises a second branch 103 having a transistor MP3, for example PMOS, in series with a transistor Q2 that is bipolar. The control terminals of transistors Q1 and Q2 are coupled, preferably connected, together and to a node N3. The emitter of transistor Q2 is coupled, preferably connected, to node NT. The control terminals of transistors MP2 and MP3 are coupled, preferably connected, together and to a node N4. In one example, node N4 is also coupled, preferably connected, to the mid-point of transistors MP3 and Q2.

The transistors MP2 and MP3 are thus current-mirrored.

In one example, the size of transistor Q1 is at least M times greater than that of transistor Q2, M ranging from 2 inclusive to 10 inclusive. Herein, the size of a bipolar transistor is, for example, the surface area of its base. It is possible to achieve a transistor sized M times greater by paralleling M transistors.

In the example illustrated, the bandgap circuit 110 further comprises a third branch 104. The third branch 104 comprises a transistor MP4 coupling the terminal for applying the supply voltage Vcc to an output node NOUT of the bandgap circuit 110. The control terminal of transistor MP4 is coupled to the mid-point N2 of transistors MP2 and Q1. The third branch 104 further comprises a resistor R4 coupling node N3 to ground, and a resistor R3 coupling the output node NOUT to node N3.

In one example, a capacitor Cc couples the mid-point N2 of transistors MP2 and Q1 to the output node NOUT. This capacitor is configured to stabilize the loop.

In the example illustrated, the bandgap circuit 110 further optionally comprises a transistor MP5, the control terminal of which is coupled, preferably connected, to the control terminals of transistors MP2 and MP3 so as to form a current mirror. Transistor MP5 couples the terminal for applying the supply voltage Vcc to a node N5 at which the output current of device 100 can be measured.

In FIG. 1, transistors MP2, MP3, MP4, and MP5 are of the PMOS-type.

By suitably selecting the ratio of resistors R2 and R1, resistor R2 can be configured to receive a voltage Vptat proportional to the absolute temperature across its terminals, while resistor R1 is in turn configured to receive a voltage Vctat that is complementary to the absolute temperature across its terminals. This results, to a first approximation, in a temperature-independent voltage at node N3 of approximately the value of the silicon bandgap (i.e., 1.26 V). Resistors R3 and R4 then act as a voltage divider bridge to obtain a reference voltage at the output node NOUT.

Bandgap circuit 110 comprises two stable operating points. One of these operating points results in zero current at the output node NOUT. The start-up circuit 120 allows this operating point to be avoided by temporarily grounding the control terminal of transistor MP4 to enable the bandgap circuit 110 to operate at its rated current.

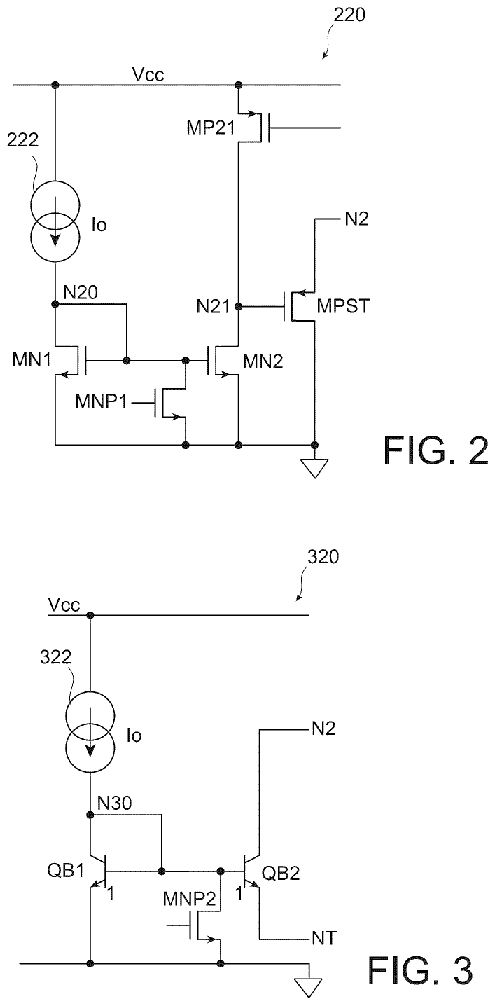

FIG. 2 illustrates a block from the device shown in FIG. 1. In particular, FIG. 2 illustrates an example of a start-up circuit 220.

The start-up circuit 220 illustrated comprises a current source 222 coupling the terminal for applying the supply voltage Vcc to a node N20. A transistor MN1, for example of the NMOS-type, couples node N20 to ground.

The start-up circuit 220 further comprises a transistor MP21, for example of the PMOS-type, coupling the terminal for applying the supply voltage Vcc to a node N21. The control terminal of transistor MP21 is coupled, preferably connected, to the control terminal of transistor MP2 of bandgap circuit 110 so as to form a current mirror.

The start-up circuit 220 also comprises a transistor MN2, for example of the NMOS-type, coupling node N21 to ground. The control terminals of transistors MN2 and MN1 are coupled, preferably connected, to each other and to node N20.

Another transistor MPST, for example of the PMOS-type, couples the node N2 of the bandgap circuit 110 to ground. The transistor MPST has a control terminal coupled, preferably connected, to node N21.

To start up, transistor MN1 is off (i.e., not conducting). The gate-source voltage of transistor MN2 is set by the current IO from current source 222 through transistor MN1. Node N21 is then grounded. The drain-source voltage of transistor MPST is reduced by a few mV and node N2 is grounded. The gate-source voltage of transistor MP4 is thus considerably increased, thereby lowering the resistance between its drain and source. A large current thus flows through resistors R3 and R4, which in turn increases the voltage at node N3. Since the voltage at node N3 has increased, a current can flow through transistors Q1 and Q2, thereby lowering the voltage at node N4. Bandgap circuit 110 has thus started. Transistor MP21 copies the current flowing through transistors Q1 and Q2, which is greater than the current through transistor MN2. Node N21 has a voltage that increases up to Vcc, thereby turning off transistor MPST. This has the effect of turning off start-up circuit 220.

Although the example illustrated in FIG. 2 enables the bandgap circuit 110 to be started up, this results in a large current peak (e.g., more than ten times the rated current), as well as a high transition voltage at nodes N5 and NOUT during starting, before the voltage stabilizes.

In addition, oscillations may occur during startup.

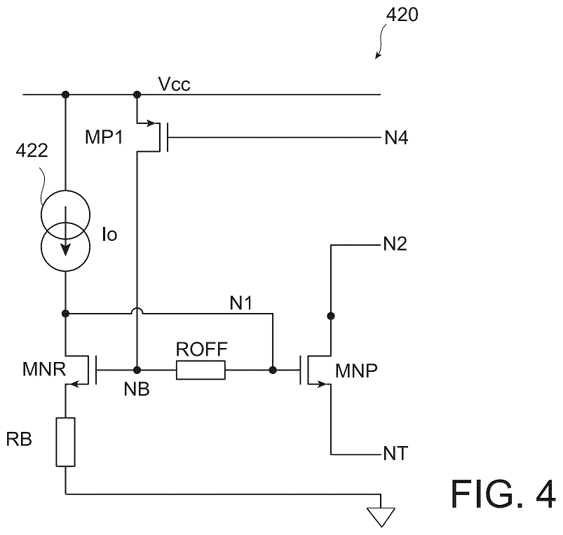

FIG. 3 illustrates a block from the device shown in FIG. 1. In particular, FIG. 3 illustrates an example of the start-up circuit 320.

The start-up circuit 320 illustrated comprises a current source 322 coupling the terminal for applying a voltage Vcc to a node N30. A transistor QB1, for example of the bipolar NPN-or NMOS-type, couples the node N30 to ground. Node N30 is coupled, preferably connected, to the control terminal of transistor QB1.

The start-up circuit 320 further comprises a transistor QB2, for example of the bipolar NPN-or NMOS-type, coupling node N2 to node NT of the bandgap circuit 110. The control terminals of transistors QB1 and QB2 are coupled, preferably connected, to each other and to node N30.

Upon starting, a current is supplied by current source 322 in order to discharge the capacitor Cc of bandgap circuit 110. Node N2 is thus connected to node NT (which is close to ground). The current through resistors R1 and R2 increases, which causes a gradual drop in the base-emitter voltage, resulting in a reduction in the starting current. When the generation circuit is started, the base-emitter voltage of transistor QB2 is low enough to turn off transistor QB2, and no current flows through it.

The start-up circuit 320 allows the current peak at starting to be limited as compared with the circuit 220.

However, the time required to establish a stable signal at the output node NOUT can reach 20 μs, whereas it would be desirable to achieve stability in less than 5 μs. Indeed, when the voltage at node NT reaches a few tens of mV, transistor QB2 is then clamped, thus limiting its ability to discharge the gate of transistor MP4.

In order to overcome the drawbacks of the example start-up circuits shown in FIGS. 2 and 3, the embodiments provide a start-up circuit for the generation circuit, a current mirror of which includes a first MOS transistor, the start-up circuit including: a second transistor and a third transistor that are current-mirrored the control terminals of which are coupled through a first resistor; and a fourth MOS transistor between a terminal for applying a supply voltage and a control terminal of the second transistor, the fourth MOS transistor being in a current mirror with respect to the first MOS transistor.

This allows current overload to be limited upon starting, but also allows the time required to establish a stable signal at the output node NOUT to be limited to around 5 μs.

FIG. 4 illustrates a block diagram of the device shown in FIG. 1. In particular, FIG. 4 illustrates an embodiment of a start-up circuit 420.

The start-up circuit 420 illustrated comprises a current source 422 coupling the terminal for applying the supply voltage Vcc to a node N1. In a non-illustrated example, the current source is outside the start-up circuit. A transistor MNR, for example of the NPN bipolar-or NMOS-type, couples node N1 to ground.

In the example illustrated, the start-up circuit comprises a transistor MNP, for example of the NPN bipolar-or NMOS-type, coupling node N2 to node NT of the bandgap circuit 110. A resistor ROFF couples, preferably connects, the control terminals of the transistors MNR and MNP to each other. In one example, the resistor ROFF is between 100 kOhms and 900 kOhms. Node N1 is coupled, preferably connected, to the control terminal of transistor MNP.

In the example illustrated, the start-up circuit 420 comprises a transistor MP1, for example of the PMOS-type, coupling the terminal for applying the voltage Vcc to the control terminal NB of transistor MNR. The control terminal of transistor MP1 is coupled, preferably connected, to node N4 of the bandgap circuit 110, i.e., coupled, preferably connected, to the control terminals of transistors MP2 and MP3 so that they form a current mirror.

In an optional example, the size of the transistor MNP is at least N times greater than that of the transistor MNR, N ranging from 2 inclusive to 10 inclusive. Herein, the size of a MOS transistor is, for example, the surface area of its gate or the ratio of width to length. It is possible, for example, to achieve an N-fold increase in transistor size by paralleling N transistors. This allows the time for stabilizing the output voltage to be reduced.

In an optional example, the transistor MNR couples node NI to ground via a resistor RB. In one example, resistor RB has a value such that the voltage drop is the same as at node NT. In one example, resistor RB has a value equal to the value of resistor R2 multiplied by N. This helps prevent the voltage between nodes NI and NT from dropping too quickly during starting. The current is thus N times greater than in the example shown in FIG. 3. This reduces the time for stabilizing the output voltage. In one example, resistor RB is between 0 Ohms and 900 kOhms.

Operation of the start-up circuit 420 is, for example, broadly similar to that shown in FIG. 3, except that in order to disconnect the start-up circuit, transistor MP1 copies the current and injects the current into the resistor ROFF, thereby reducing the voltage present at the control terminal of transistor MNP by several hundred mV, for example between 100 mV and 1 V, i.e. below its threshold, thus turning OFF the transistor MNP quickly. The start-up circuit is thus disconnected without overloading and more quickly as compared to the examples shown in FIGS. 2 and 3.

Various embodiments and variants have been described. Those skilled in the art will understand that certain features of these embodiments can be combined and other variants will readily occur to those skilled in the art. In particular, the transistors MNR and MNP in the example illustrated in FIG. 4 could be bipolar transistors, for example of the NPN-type. Those skilled in the art will also be able to invert the transistor types NMOS to PMOS, or NPN to PNP, and vice versa, by modifying the associated voltages and arranging the circuits according to their knowledge.

Finally, the practical implementation of the embodiments and variants described herein is within the capabilities of those skilled in the art based on the functional description provided hereinabove. In particular, the start-up circuit 420 could be implemented by those skilled in the art, with a bandgap circuit 110 different from that described in FIG. 1. For example, the generation circuit could be a Brokaw-type circuit, as long as it contains a current mirror that can be copied with transistor MP1, and the copied current causes a voltage drop that turns transistor MNP quickly OFF in order to cause disconnection of the start-up circuit.

1. A start-up circuit of a bandgap circuit for generating a reference voltage, the bandgap circuit including a current mirror having a first transistor, comprising:
a second transistor and a third transistor in a current mirror configuration, control terminals of the second transistor and the third transistor being coupled through a first resistor; and
a fourth transistor coupled between a terminal for applying a supply voltage and a control terminal of the second transistor, the fourth transistor being in a current mirror configuration with the first transistor.

2. The start-up circuit according to claim 1, further comprising a current source that couples:
the terminal for applying a supply voltage to the control terminal of the third transistor, and
the terminal for applying a supply voltage to a conduction terminal of the second transistor.

3. The start-up circuit according to claim 1, further comprising a second resistor, wherein the second transistor couples the control terminal of the third transistor to ground via the second resistor.

4. The start-up circuit according to claim 1, wherein a size of the third transistor is at least N times greater than a size of the second transistor, N ranging from 2 inclusive to 10 inclusive.

5. The start-up circuit according to claim 1, wherein the second transistor and the third transistor are NMOS transistors, and the fourth transistor is a PMOS transistor.

6. The start-up circuit according to claim 1, wherein the second transistor and the third transistor are bipolar transistors, and the fourth transistor is a PMOS transistor.

7. The start-up circuit according to claim 1, wherein the fourth transistor is connected directly to the control terminal of the second transistor.

8. A bandgap device for generating a reference voltage, comprising:
the start-up circuit according to claim 1; and
a bandgap circuit for generating a reference voltage, the bandgap circuit comprising a first branch having the first transistor in series with a fifth transistor, wherein the fifth transistor is a bipolar transistor.

9. The bandgap device according to claim 8, wherein the bandgap circuit further comprises:
a third resistor coupled to ground in series with a fourth resistor coupled to an emitter of the fifth transistor;
wherein the fourth resistor is configured to receive a voltage proportional to absolute temperature across its terminals, and the third resistor is configured to receive a voltage complementary to absolute temperature across its terminals.

10. The bandgap device according to claim 9, wherein:
the fourth transistor has a control terminal coupled to a control terminal of the first transistor; and
the third transistor couples a mid-point of the first transistor and the fifth transistor to a mid-point of the third resistor and the fourth resistor.

11. The bandgap device according to claim 9, wherein the bandgap circuit further comprises a second branch having a sixth transistor in series with a seventh transistor, wherein the seventh transistor is a bipolar transistor, control terminals of the fifth transistor and the seventh transistor being both coupled to a first node, and control terminals of the first transistor, the fourth transistor, and the sixth transistor being coupled to each other.

12. The bandgap device according to claim 11, wherein a mid-point of the sixth transistor and the seventh transistor is coupled to the control terminals of the first transistor, the fourth transistor, and the sixth transistor.

13. The bandgap device according to claim 11, wherein the bandgap circuit further comprises a third branch having:
an eighth transistor coupling the terminal for applying a supply voltage to an output node of the bandgap circuit, a control terminal of the eighth transistor being coupled to a mid-point of the first transistor and the fifth transistor;
a fifth resistor coupling the first node to ground; and
a ninth transistor coupling the output node to the first node.

14. The bandgap device according to claim 13, wherein a capacitor couples the mid-point of the first transistor and the fifth transistor to the output node.

15. The bandgap device according to claim 13, wherein the first transistor, the sixth transistor, and the eighth transistor are PMOS transistors.

16. The bandgap device according to claim 11, wherein a size of the fifth transistor is at least M times greater than a size of the seventh transistor, M ranging from 2 inclusive to 10 inclusive.

17. A bandgap device for generating a reference voltage, comprising: the start-up circuit according to claim 1, wherein the start-up circuit further comprises a second resistor, and the second transistor couples the control terminal of the third transistor to ground via the second resistor; and a bandgap circuit for generating a reference voltage, the bandgap circuit comprising: a first branch having the first transistor in series with a fifth transistor, wherein the fifth transistor is a bipolar transistor.

18. A bandgap device for generating a reference voltage, according to claim 17, wherein the bandgap circuit comprises: a third resistor coupled to ground in series with a fourth resistor coupled to an emitter of the fifth transistor, the fourth resistor being configured to receive a voltage proportional to absolute temperature across its terminals, and the third resistor being configured to receive a voltage complementary to absolute temperature across its terminals; wherein the second resistor has a value equal to a value of the third resistor multiplied by N, wherein N ranges from 2 inclusive to 10 inclusive.

19. A bandgap device for generating a reference voltage, according to claim 17, wherein the bandgap circuit comprises: a third resistor coupled to ground in series with a fourth resistor coupled to an emitter of the fifth transistor, the third resistor being configured to receive a voltage proportional to absolute temperature across its terminals, and the fourth resistor being configured to receive a voltage complementary to absolute temperature across its terminals;
wherein the second resistor has a value equal to a value of the third resistor multiplied by N, wherein N ranges from 2 inclusive to 10 inclusive.

20. A method for starting a bandgap circuit that generates a reference voltage, the bandgap circuit including a current mirror having a first transistor, the method comprising:
providing a start-up circuit having:
a second transistor and a third transistor in a current mirror configuration, control terminals of the second transistor and the third transistor being coupled through a first resistor; and
a fourth transistor coupled between a terminal for applying a supply voltage and a control terminal of the second transistor, the fourth transistor being in a current mirror configuration with the first MOS transistor;
supplying current through the start-up circuit to initiate operation of the bandgap circuit; and
disconnecting the start-up circuit by switching the fourth transistor off when the bandgap circuit reaches stable operation.

21. The method of claim 20, further comprising starting the bandgap circuit by using the start-up circuit, and switching the start-up circuit off after the bandgap circuit has started.

22. A method for starting a bandgap circuit that generates a reference voltage using a start-up circuit, the bandgap circuit including a current mirror having a first transistor, the start-up circuit including a second transistor and a third transistor in a current mirror configuration with control terminals coupled through a first resistor and a fourth transistor coupled between a terminal for applying a supply voltage and a control terminal of the second transistor, the fourth transistor being in a current mirror configuration with the first transistor, the method comprising:
supplying current through the start-up circuit to discharge a capacitor of the bandgap circuit and initiate current flow in the bandgap circuit; and
automatically disconnecting the start-up circuit when the bandgap circuit reaches stable operation by the fourth transistor copying current from the bandgap circuit and injecting the copied current into the first resistor to reduce voltage at the control terminal of the third transistor below a threshold voltage, thereby turning off the third transistor.

23. The method according to claim 22, wherein supplying current through the start-up circuit comprises connecting a mid-point of the first transistor and a bipolar transistor of the bandgap circuit to a node that is close to ground potential through the third transistor.

24. The method according to claim 22, wherein the method limits current overload during starting and establishes a stable signal at an output node of the bandgap circuit.

25. The method according to claim 22, wherein the second and third transistors are NMOS transistors or bipolar transistors, and the fourth MOS transistor is a PMOS transistor.
